(19) United States
(12) Patent Application Publication
(10) Pub. No.: US 2026/0222977 A1
(43) Pub. Date: Jul. 30, 2026

(54) METHOD FOR IDENTIFYING HOTSPOT EXTERNAL LINK, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Jian ZHANG, Beijing (CN); Zihao LIU, Beijing (CN)

(73) Assignee: BEIJING BAIDU NETCOM SCIENCE TECHNOLOGY CO., LTD., Beijing (CN)

(21) Appl. No.: 19/575,614

(22) Filed: Mar. 23, 2026

(30) Foreign Application Priority Data
Sep. 29, 2025 (CN) 202511415119.X

(51) Int. Cl. H04W 48/16; H04W 24/10

(52) U.S. Cl. CPC H04W 48/16; H04W 24/10

(57) ABSTRACT

Provided is a method for identifying a hotspot external link, an electronic device, and a storage medium, relating to the field of data processing technologies, and especially to the fields offle sharing and data statistics. The method includes: in response to an operation of a user on an external link, obtaining an external link identifier, an area code of the user and an operation type, to construct a triple counter, wherein each triple counter corresponds to a dimension of (external link, area, operation type); performing hierarchical processing and filtering on the triple counter via multi-level cache, to identify a potential hotspot triple; identifying a sustained hotspot external link based on the potential hotspot triple by incorporating counter values of a current time period and previous M historical time periods, wherein M is a positive integer; and outputting an identification result of the hotspot external link.

### CROSS-REFERENCE TO RELATED APPLICATIONS

The present application claims priority to Chinese Patent Application No. CN202511415119.X, filed with the China National Intellectual Property Administration on Sep. 29, 2025, the disclosure of which is hereby incorporated herein by reference in its entirety.

### TECHNICAL FIELD

The present disclosure relates to the field of data processing technologies, and particularly to the fields of file sharing and data statistics, which can be used in application scenarios such as external link identification. Specifically, the present disclosure relates to a method and apparatus for identifying a hotspot external link, an electronic device, and a storage medium.

### BACKGROUND

File storage and sharing services allow users to share resources via external links. When users share external links of a file on various platforms, it can lead to widespread dissemination and access. The timely and accurate identification of these external links is crucial for optimizing network resource allocation and implementing precise operational strategies to enhance service value. However, existing technical solutions struggle to meet the requirements of both low computational cost and high real-time performance when faced with massive volumes of external link access data.

### SUMMARY

The present disclosure provides a method and apparatus for identifying a hotspot external link, an electronic device, and a storage medium.

According to a first aspect of the present disclosure, provided is a method for identifying a hotspot external link, including:
in response to an operation of a user on an external link, obtaining an external link identifier, an area code of the user and an operation type, to construct a triple counter, wherein each triple counter corresponds to a dimension of (external link, area, operation type);
performing hierarchical processing and filtering on the triple counter via multi-level cache, to identify a potential hotspot triple;
identifying a sustained hotspot external link based on the potential hotspot triple by incorporating counter values of a current time period and previous M historical time periods, wherein M is a positive integer; and
outputting an identification result of the hotspot external link.

According to a second aspect of the present disclosure, provided is an apparatus for identifying a hotspot external link, including:
an operation counting module, configured to, in respond to an operation of a user on an external link, obtain an external link identifier, an area code of the user and an operation type, to construct a triplet counter, where each triple counter corresponds to a dimension of (external link, area, operation type);
a hierarchical filtering module, configured to perform hierarchical processing and filtering on the triple counter via multi-level cache, to identify a potential hotspot triple;
a hotspot identification module, configured to identify a sustained hotspot external link based on the potential hotspot triplet by incorporating counter values of a current time period and previous M historical time periods, wherein M is a positive integer; and
a result output module, configured to output an identification result of the hotspot external link.

According to a third aspect of the present disclosure, provided is an electronic device, including:
at least one processor; and
a memory connected in communication with the at least one processor;
where the memory stores an instruction executable by the at least one processor, and the instruction, when executed by the at least one processor, enables the at least one processor to execute the method of any embodiment of the present disclosure.

According to a fourth aspect of the present disclosure, provided is a non-transitory computer-readable storage medium storing a computer instruction thereon, and the computer instruction is used to cause a computer to execute the method of any embodiment of the present disclosure.

According to a fifth aspect of the present disclosure, provided is a computer program product including a computer program, and the computer program, when executed by a processor, implements the method of any embodiment of the present disclosure.

By adopting the solution of the present disclosure, a multi-level cache mechanism is introduced to perform hierarchical processing and filtering on triple counters, effectively overcoming the performance bottlenecks of existing technologies in high-concurrency scenarios and significantly improving the efficiency and real-time performance of hotspot external link identification.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to facilitate a better understanding of the present disclosure and are not to be construed as limiting the present disclosure. In the drawings:

FIG. 1 shows a schematic flowchart of a method for identifying a hotspot external link according to an embodiment of the present disclosure;

FIG. 2 shows a schematic structural diagram of a three-level cache according to an embodiment of the present disclosure;

FIG. 3 shows another schematic flowchart of a method for identifying a hotspot external link according to an embodiment of the present disclosure;

FIG. 4 shows a schematic structural diagram of an apparatus for identifying hotspot external links according to an embodiment of the present disclosure;

FIG. 5 shows a schematic scenario diagram of a method for identifying a hotspot external link according to an embodiment of the present disclosure; and

FIG. 6 shows a schematic structural block diagram of an electronic device for implementing the method for identifying a hotspot external link according to an embodiment of the present disclosure.

### DETAILED DESCRIPTION

The following describes exemplary embodiments of the present disclosure with reference to the accompanying drawings. Various details of the embodiments of the present disclosure are included to facilitate understanding, and should be regarded as merely exemplary. Accordingly, those having ordinary skill in the art should recognize that various changes and modifications can be made to the embodiments described herein without departing from the scope of the present disclosure. Likewise, for clarity and conciseness, descriptions of well-known functions and structures are omitted in the following description.

As used herein, the terms “first”, “second”, etc. are used to refer to a plurality of similar elements and to distinguish between them, and are not intended to imply a specific order or to limit the number to two. For example, reference to a first feature and a second feature indicates the presence of two types of features or two features. The first feature may be one or more, and the second feature may also be one or more.

In addition, in order to better illustrate the present disclosure, numerous specific details are given in the following specific implementations. Those having ordinary skill in the art should understand that the present disclosure may be performed without certain specific details. In some examples, methods, means, elements and circuits well known to those having ordinary skill in the art are not described in detail, in order to highlight the subject matter of the present disclosure.

Before introducing the technical solutions of the embodiments of the present disclosure, the technical terms that may be used in the present disclosure are explained as follows.

External link: a link generated by a user for a personal file in a storage system that can be accessed externally. Other people can directly save, browse, play, or download the file through this link without logging into the storage system.

In the related art, there are currently two solutions for hotspot resource statistics. One solution is implemented using simple counters in a Remote Dictionary Server (Redis). When an external link is browsed every time, its access count is incremented by one, and the access data of all counters is periodically aggregated and sorted. However, for Redis simple counters, when the volume of access data is large enough, the number of counters that need to be maintained becomes extremely high, leading to excessive computational costs that are difficult to bear. Another solution involves using a big data platform for statistics. Although it possesses strong computing power and can handle large-scale data, its computational resource consumption is relatively high. In scenarios requiring minute-level real-time identification, to meet the demand for large-scale data statistics every minute, the consumption of computing resources increases dozens of times compared to hour-level real-time identification, making it impossible to effectively meet real-time requirements and facing significant resource pressure.

To at least partially solve one or more of the above problems and other potential problems, the present disclosure proposes a method for identifying a hotspot external link. By adopting a technical approach that incorporates counter construction based on a triple (external link, area, operation type) with hierarchical processing via multi-level cache, the system can handle high-concurrency access with lower data processing latency. This significantly improves the overall identification efficiency of hotspot external links and system throughput while ensuring minute-level real-time performance. First, through the step-by-step filtering mechanism of the multi-level cache, a sharp reduction in data volume may be achieved, effectively overcoming the defects of the prior art, such as the high computational cost of maintaining massive counters or the huge resource consumption of big data platforms, and significantly reducing the system's storage and computing load. Second, this method ensures minute-level real-time performance of hotspot identification, enabling the business system to respond promptly to changes in hotspot topics and improving the timeliness and accuracy of operational strategy adjustments. Furthermore, the multi-dimensional statistical capability based on area and operation type allows the system to accurately adapt to user behavior characteristics and policy environments in different areas, enhancing the system's applicability and management efficiency.

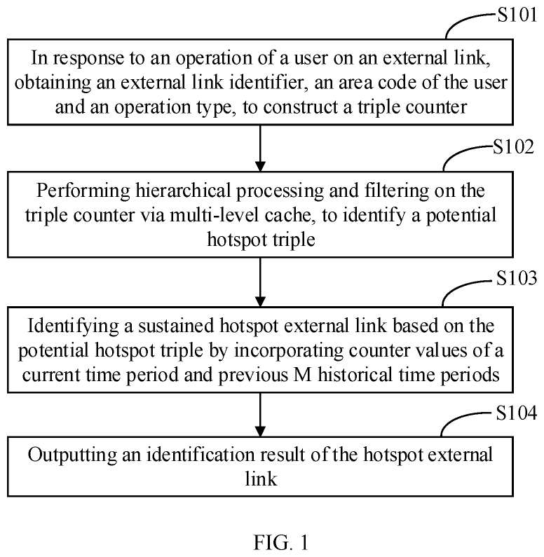

Embodiments of the present disclosure provide a method for identifying a hotspot external link. FIG. 1 shows a schematic flowchart of a method for identifying a hotspot external link according to an embodiment of the present disclosure. The method for identifying a hotspot external link may be applied to an apparatus for identifying hotspot external links. The apparatus for identifying hotspot external links may be disposed in an electronic device. The electronic device may include but not limited to fixed devices and/or mobile devices. For example, fixed devices may include but not limited to servers, which may be cloud servers or ordinary servers. For example, mobile devices may include but not limited to external link identification devices, which may be mobile phones, tablet computers, vehicle-mounted terminals, etc. In some possible implementations, the method for identifying a hotspot external link may also be implemented by a processor executing a computer-readable instruction stored in a memory. As shown in FIG. 1, the method for identifying a hotspot external link may include:
S101: In response to an operation of a user on an external link, obtaining an external link identifier, an area code of the user and an operation type to construct a triple counter;
S102: Performing hierarchical processing and filtering on the triple counter via multi-level cache to identify a potential hotspot triple;
S103: Identifying a sustained hotspot external link based on the potential hotspot triple by incorporating counter values of a current time period and previous M historical time periods; and
S104: Outputting an identification result of the hotspot external link.

Here, the external link identifier may refer to a unique identifier of the external link. In an embodiment of the present disclosure, the external link identifier may be a unique identity document (ID) generated for each external link, which can be used to distinguish different external links.

Here, the area code of the user may refer to an area or region code determined based on the user's Internet Protocol (IP) address through geolocation technology. In an embodiment of the present disclosure, the area code of the user may be an area code conforming to the International Organization for Standardization (ISO) standard.

Here, the operation type may refer to an action performed by the user on the external link. In an embodiment of the present disclosure, the operation type may include at least one of browsing, playing, downloading, sharing, or commenting.

Here, the counter may refer to a tool or mechanism used to record the number of times an event occurs, with its core function being to count the quantity of a specific event or object. Particularly, each triple counter may correspond to a dimension of (external link, area, operation type).

In an embodiment of the present disclosure, when a user performs an operation on an external link, specific information about the operation may be recorded, including the corresponding external link identifier, the area code determined via the user's IP address, and the operation type of the user. This information may be then used to form a unique triple. Illustratively, when a user performs a download operation on external link A in area CN, the constructed triple counter may be {A_CN_download}.

Here, the multi-level cache may refer to a technology for storing and processing data in hierarchical layers. In an embodiment of the present disclosure, the multi-level cache may be divided into a large-capacity first-level cache and a smaller-capacity second-level cache, used to filter and store data at different levels using different strategies.

Here, the potential hotspot triple may refer to a triple whose count value increases rapidly within a short period and which may become a hotspot. In an embodiment of the present disclosure, the potential hotspot triple may not fully meet the final hotspot criteria but exhibit a potential trend of becoming a hotspot.

In an embodiment of the present disclosure, data of the triple counters may enter different levels of cache according to their popularity distribution. Illustratively, the first-level cache may store data of triples accessed frequently within a short period and periodically transfer the triples accessed frequently to the second-level cache. The second-level cache may process this count data more comprehensively, and identify triples with higher count values or faster growth rates through mechanisms such as sorting and filtering. Finally, the identified triples may be regarded as potential hotspot triples.

Here, the current time period may refer to a time interval currently used for statistics. In an embodiment of the present disclosure, the current time period may be a custom minute-level or hour-level time window.

Here, the historical time period may refer to several previous time intervals used statistics. In an embodiment of the present disclosure, the historical time period may be used for comparison and analysis of sustained change trends.

Here, the sustained hotspot external link may refer to an external link that exhibits high popularity over multiple time periods. In an embodiment of the present disclosure, the sustained hotspot external link may have consistently high access counts or operation counts over a period of time.

In an embodiment of the present disclosure, the counter value of the current time period may be compared with the counter data of the previous M historical time periods based on the filtered potential hotspot triple. Illustratively, if the counter value of a certain triple is still high in the current time period and shows sustained high popularity or a growth trend compared with historical data, the external link corresponding to this triple may be identified as the sustained hotspot external link.

Here, the identification result may refer to the output of the identified hotspot external link. In an embodiment of the present disclosure, the identification result may include information such as the external link identifier, area code, operation type, and its popularity level.

In an embodiment of the present disclosure, for an external link identified as a hotspot, a corresponding result list or log record may be generated, specifically including the identifier of the external link, popularity data, its area code, and the popularity level. Illustratively, the identification result may be output in the form of a report, real-time push, or Application Programming Interface (API).

According to the technical solution of the embodiments of the present disclosure, by adopting a triple counter structure based on the external link, the area, and the operation type, fine-grained statistics of user access operation may be implemented, significantly improving the accuracy and dimensional richness of hotspot identification. With the help of a hierarchical processing mechanism of multi-level cache, high-frequency access data may be aggregated and filtered in real-time in the first-level cache, effectively reducing the system's computational load on global data and greatly enhancing data processing efficiency and overall system performance. Furthermore, by setting a minute-level time period for hotspot judgment and output, the system can complete identification tasks with near real-time latency, fully meeting the business end's requirements for high timeliness. Additionally, by integrating access data of the current time period and multiple historical time periods, the system can dynamically capture the persistence and change trends of the external link popularity, enabling continuous tracking and intelligent prediction of hotspot resources. Ultimately, the output structured hotspot identification results may provide a standardized data interface for a downstream business system, offer highly timely data input for automated decision-making functions such as automatic resource scheduling and dynamic policy configuration, thereby improving the automation level of system management.

In some embodiments, the multi-level cache may include at least two levels of cache. In some embodiments, the hierarchical processing and filtering may include: in a first-level cache, performing updating and preliminarily filtering on the triple counter according to a first predetermined strategy to obtain a first candidate set; in a next-level cache, performing further filtering on the first candidate set according to a second predetermined strategy to obtain a second candidate set with a data volume smaller than that of the first candidate set; and determining the potential hotspot triple based on the second candidate set.

Here, the first-level cache may refer to a first layer in the caching mechanism, which may be used to store triple counters for high-frequency access or operations in the data stream. In an embodiment of the present disclosure, the first-level cache may have the largest capacity, and the maximum number of counters that can be stored may be a product of the number of external links, the number of areas, and the number of operation types.

Here, the first predetermined strategy may refer to a set of rules or algorithms implemented in the first-level cache for filtering or updating data. In an embodiment of the present disclosure, the first predetermined strategy may adopt strategies such as incremental statistics of counters, access frequency sorting, or fast filtering within a time window.

Here, the first candidate set may refer to a set of triples generated after preliminary filtering in the first-level cache. In an embodiment of the present disclosure, the triples in the first candidate set may have high popularity or a rapidly growing trend.

In an embodiment of the present disclosure, preliminary filtering of counter data may be performed in the first-level cache according to the first predetermined strategy. Illustratively, the filtering rules of the first predetermined strategy may include: setting a count threshold to filter high-popularity triples; sorting by access frequency to select a most active triple; or dynamically tracking hotspot growth based on access data within a short time window. After the filtering is completed, the first candidate set may be generated, containing the preliminarily identified high-popularity triples.

Here, the next-level cache may refer to a second layer or a deeper layer in the caching mechanism, which may be used to further store and filter the data filtered in the first-level cache. In an embodiment of the present disclosure, the capacity of the next-level cache may be much smaller than that of the first-level cache.

Here, the second predetermined strategy may refer to a set of more in-depth filtering rules or algorithms implemented in the next-level cache for further narrowing down the scope of the candidate set. In an embodiment of the present disclosure, the second predetermined strategy may include: comprehensive popularity calculation, growth trend determination, or cross-time-period comparative analysis, etc.

Here, the second candidate set may refer to a data set obtained after filtering by the second predetermined strategy in the next-level cache. In an embodiment of the present disclosure, the data volume of the second candidate set may be smaller than that of the first candidate set, but a precision of the second candidate set may be higher, containing the potential hotspot triple.

In an embodiment of the present disclosure, the first candidate set generated in the first-level cache may be passed to the next-level cache for further filtering and processing. Further, in the next-level cache, the second predetermined strategy is used to filter the first candidate set. Illustratively, the filtering rules of the second predetermined strategy may include: filtering for a triple with the most significant hotspot change trends by integrating a counter value and a popularity growth rate; performing comparative analysis across time periods to retain a triple that has been active across multiple time periods; or filtering based on geographical distribution to grant priority to a triple with surging access volumes in a certain area. After the filtering is completed, the second candidate set may be generated, with a data volume smaller than the first candidate set but higher precision, containing the final potential hotspot triple.

In an embodiment of the present disclosure, the potential hotspot triple may be determined based on the second candidate set. Illustratively, each triple in the second candidate set may be determined as a potential hotspot triple. Alternatively, further filtering may be performed within the second candidate set, and a filtering result may be determined as the potential hotspot triple. Particularly, the potential hotspot triple may have characteristics such as high access volume, significant growth trends, and strong popularity persistence.

In this way, the use of multi-level caching may layer the data processing task, avoiding direct processing of the full dataset, reducing computational pressure, and improving overall processing efficiency. The first-level cache may be responsible for quickly filtering high-frequency data, while the next-level cache may be responsible for in-depth analysis and precise filtering, thereby enabling efficient data processing. The first-level cache may reduce the scale of data requiring further processing through preliminary filtering. The next-level cache may further narrow down the data range, reducing storage requirements and computational resource consumption, especially in a massive data scenery, thereby effectively avoiding the high cost of full-scale computation. The first-level cache may process data in real-time, enabling rapid response to user's operation and generation of the first candidate set. The next-level cache, may ensure the real-time requirements for minute-level hotspot external link identification by incorporating more complex strategies for further hotspot identification. By gradually narrowing down the data range through hierarchical filtering, from the preliminary candidate to the final identification of the potential hotspot triple, it is possible to enable more accurate judgment by comprehensively considering multi-dimensional factors (such as popularity, growth trends, geographical distribution, etc.), avoiding misjudgment or omission.

In some embodiments, the at least two levels of cache may specifically include a first-level cache, a second-level cache, and a third-level cache. In some embodiments, the hierarchical processing and filtering may include: updating a counter value with a minute-level time period granularity in the first-level cache, and setting a minute-level expiration time for each counter; when the counter value in the first-level cache exceeds a preset threshold, storing corresponding information into the second-level cache; and in the third-level cache, periodically querying the second-level cache and sorting the obtained triples to filter for the potential hotspot triple.

Here, the minute-level expiration time may refer to a storage time limit for each counter in the first-level cache. In an embodiment of the present disclosure, if a lifetime of any counter exceeds the minute-level expiration time, this counter will be automatically removed. Illustratively, the minute-level expiration time may be 1 to 10 minutes, and may be dynamically adjusted based on load.

In an embodiment of the present disclosure, in the first-level cache, the value of a triple counter may be updated with a minute-level time period granularity. Illustratively, when a user performs an operation on an external link, the counter value corresponding to this external link, the area it belongs to, and the operation type may be increased by 1, and this counter operates with a minute-level time period granularity. Further, each counter may be set with a minute-level expiration time. If the lifetime exceeds the minute-level expiration time, the counter may be removed to release memory resources.

Here, the first-level cache may be a first layer of the caching mechanism, which may used to store short-term high-frequency access data and update the counters in real-time, thereby ensuring efficient processing of hotspot data. Illustratively, the first-level cache may be implemented based on a Redis database, to store counters in key-value pairs, with the key being a triple string and the value being an integer count.

Here, the preset threshold may be used to determine whether to transfer a counter from the first-level cache to the second-level cache, and may typically be a limit on the counter value. Only when the counter value exceeds this preset threshold, the triple may be considered to possibly have some popularity or potential trend.

Here, the corresponding information may refer to information related to the counter. In an embodiment of the present disclosure, the corresponding information may be transferred to the second-level cache for further processing.

Here, the second-level cache may be a second layer of the caching mechanism, which may be used to store data filtered from the first-level cache. In an embodiment of the present disclosure, the second-level cache may be implemented based on a Redis database, to store counters in key-value pairs, with the key being a triple string and the value being an integer count.

In an embodiment of the present disclosure, when a counter value reaches or exceeds a preset threshold, the corresponding information related to this counter may be stored in the second-level cache. Further, in the second-level cache, possible hotspot data may be further filtered from the data transferred from the first-level cache, and these filtered hotspot data may be stored for subsequent analysis.

Here, the third-level cache may be a third layer of the caching mechanism, which may be used to periodically query, sort, and precisely filter the data filtered from the second-level cache, ultimately identifying the potential hotspot triple.

In an embodiment of the present disclosure, the third-level cache may periodically query the triple data stored in the second-level cache and sort count values of the triple data. Illustratively, more filtering criteria (e.g., popularity increment, time trends, etc.) may also be incorporated to ultimately identify the potential hotspot triple.

In this way, through the three-level caching mechanism, data hierarchical processing and gradual filtering can be achieved, effectively reducing storage and computational pressure, and improving overall processing efficiency. The setting of minute-level expiration time may ensure that data in the first-level cache always has high timeliness, avoiding resource waste caused by storing invalid data. The preset threshold and data volume reduction strategy may enable hotspot data to quickly stand out from a large amount of ordinary data, ensuring the accuracy of filtering results. The sorting and multi-dimensional filtering in the third-level cache may further enhance the accuracy of hotspot identification, while also supporting periodic analysis and processing of data.

In some embodiments, updating the counter value with a minute-level time period granularity in the first-level cache may include: in response to the operation of the user on the external link, determining a current time period based on an operation time; and incrementing a value of a corresponding triple counter based on the current time period.

Here, the current time period may refer to a time window divided according to a preset time unit (e.g., minute), and may be used to count a time segment during which the user operation occurs. In an embodiment of the present disclosure, the current time period may use minute as the time period granularity, with each time period representing an independent time segment.

In an embodiment of the present disclosure, when a user performs an operation on an external link, a timestamp of the operation may first be captured. Subsequently, the timestamp may be compared with predefined time periods to determine which time period the operation belongs to.

In an embodiment of the present disclosure, a triple counter corresponding to the current time period may first be determined based on the external link identifier of the user's operation, area code of the user and the operation type, and the value of the triple counter may be incremented by 1.

In this way, the minute-level time period may ensure that user operation data can be quickly aggregated into the corresponding time window, providing high-precision time segmentation for real-time hotspot identification. At the same time, the operation of incrementing the counter value can quickly reflect changing trends in user behavior, providing an accurate statistical foundation for subsequent filtering and analysis.

In some implementations, updating the counter value in the first-level cache may be achieved by: generating a count update instruction for each user operation event; and processing the count update instruction to perform an operation of incrementing by 1 on the corresponding counter in the first-level cache.

Specifically, when a user performs a certain operation event (for example, browsing, playing, or downloading an external link), relevant information about the operation may be captured, including the external link identifier, the area code of the user, operation type, operation time, and the like. Subsequently, the count update instruction may be generated based on the above information. The content of the count update instruction may include the triple and the operation type indicating that the triple counter is required to be increment (e.g., incremented by 1). This step may convert a user behavior into a standardized instruction, facilitating subsequent operation processing. Further, the count update instruction may be sent to the first-level cache for processing. The first-level cache may find the corresponding counter based on the triple information in the instruction and perform the increment operation.

In some embodiments, the corresponding information may include a triple identifier and a counter value.

Here, the triple identifier may be used to uniquely identify a combined value of a specific set of data, and be typically composed of information from three dimensions. In an embodiment of the present disclosure, the triple identifier may be composed of an external link identifier, an area code, and an operation type. Among these, the external link identifier may be used to mark the specific external link and be a core object of data processing, the area code may be used to identify the region or area where the user is located, enabling differentiation of access traffic by geography, and the operation type may be used to identify the specific action performed by the user, enabling differentiation of various interaction methods.

In an embodiment of the present disclosure, when a counter value in the first-level cache exceeds a preset threshold, a data transfer logic may be triggered to store the triple identifier and counter value corresponding to this counter into the second-level cache. Specifically, it can first check whether a record matching the triple identifier already exists in the second-level cache. If the record exists, the counter value is updated, accumulating the counter value from the first-level cache into the corresponding record in the second-level cache to ensure continuity of data statistics. Conversely, if there is no corresponding record in the second-level cache, a new entry may be created, storing the triple identifier and counter value into the second-level cache, while recording a relevant timestamp or other metadata for subsequent analysis. Particularly, when storing data in the second-level cache, an additional filtering condition may be set or data compression may be performed according to business needs to further optimize the data storage structure of the second-level cache.

In this way, the storage strategy of the second-level cache can make the data timelier and more structured, providing more accurate candidate data for subsequent hotspot analysis, while reducing storage and computational costs.

In some embodiments, the preset threshold may be dynamically set based on historical hotspot data statistics, and differentiated thresholds may be set for different areas or operation types.

Here, historical hotspot data may refer to a data set related to a hotspot obtained after statistics and analysis of user operations over a past period of time.

In an embodiment of the present disclosure, the historical access data of an external link may be summarized and analyzed periodically in advance. Rationally, user operation records from the past week or month may be collected, the access data for each triple may be counted, and this data may be archived as historical hotspot data. Subsequently, the hotspot regularity of each external link may be analyzed based on the historical hotspot data. Illustratively, if a user in a certain area shows a high access volume trend for a specific operation type, a higher threshold can be set for this area and operation type to avoid misjudging a hotspot. Similarly, if the historical access volume for a certain area or operation type is low, a lower threshold can be set to facilitate timely identification of a potential hotspot.

In this way, by dynamically setting the preset threshold based on historical hotspot data, the system can achieve more accurate and flexible hotspot identification, overcoming the limitation of poor adaptability associated with a fixed threshold. By setting differentiated thresholds for different areas or operation types, the identification accuracy in specific scenarios may be further optimized, effectively reducing both false positive and false negative rates. Such dynamic adjustment mechanism based on historical data may endow the system with the ability to perceive and adapt to long-term changes in user behavior patterns, enhancing the adaptability and robustness of the algorithm.

In some embodiments, periodically querying the second-level cache in the third-level cache may include periodically querying the second-level cache by using an asynchronous query with a minute interval in the third-level cache.

In an embodiment of the present disclosure, the time interval for the third-level cache to periodically query the second-level cache may be first set, using minute as the unit. Particularly, the time interval may be determined by a pre-configured parameter, and the query may be performed at the end of each time period, so as to ensure that the query task is executed at a fixed frequency, avoiding resource waste caused by frequent queries, while enabling timely acquisition of updated hotspot data. Furthermore, to avoid blocking the real-time processing flow due to query operations, an asynchronous query mechanism may be adopted. Specifically, an event may be triggered when the set query time interval is reached, pushing the query task to an asynchronous processing thread or module, where an independent worker thread may be responsible for processing the task. Alternatively, the query task may be sent to a message queue in the form of messages, and the second-level cache may consume the query tasks one by one through the message queue to perform query operation of the third-level cache. Furthermore, after the asynchronous query task is started, a query request may be initiated from the third-level cache to the second-level cache, where the query request can filter data in the second-level cache according to a preset rule. Particularly, query operations may be typically executed in batches, allowing multiple eligible second-level cache records to be obtained at once to improve query efficiency.

In this way, by implementing an asynchronous query through the message queue or t event-driven mechanism, the data query task may be decoupled from the real-time counting process flow, eliminating the blocking of the main thread by query operations and significantly improving the system's throughput and response speed in a high-concurrency scenery. At the same time, by setting a periodic scheduled query strategy, it ensures that the third-level cache can obtain updated hotspot candidate data in a timely manner while avoiding unnecessary resource overhead caused by continuous polling, achieving an optimized balance between processing efficiency and system load.

In some embodiments, sorting the obtained triples to filter for the potential hotspot triple may include sorting counter values in descending order by using a heap sort algorithm to obtain the Top-K potential hotspot triples.

Here, the heap sort algorithm may refer to a selection sort algorithm based on a heap data structure. In an embodiment of the present disclosure, the heap sort algorithm can use a min-heap sort, dynamically adjusting to maintain the characteristic of the min-heap, thereby achieving rapid filtering of Top-K data.

In an embodiment of the present disclosure, the min-heap may be initialized according to the heap sort algorithm, with the heap's capacity being set to K based on the number of Top-K hotspot triples to be obtained. The characteristic of the min-heap may ensure that the heap stores the triples with the current largest K counter values, and the heap top may be always the smallest among these current hotspot triples. Subsequently, records can be read one by one from the obtained triple data, with each record including a triple identifier and a counter value. Specifically, during a traversal process, each record may be dynamically adjusted against the current heap. Illustratively, if the number of elements in the heap is less than K, the triple may be directly inserted into the heap; if the heap is already full (i.e., the heap already has K triples), the counter value of the record may be compared with the heap top (the minimum value). If the counter value is greater than the heap top, the heap top may be replaced, and the heap structure is dynamically adjusted to maintain the characteristic of the min-heap. Conversely, if the counter value is less than or equal to the heap top, the record may be skipped directly. Finally, after the traversal is complete, the elements stored in the heap may be the K potential hotspot triples with the largest counter values. At this point, the triple data in the heap may be popped out and sorted in descending order. The final result may be the Top-K potential hotspot triples. Particularly, K should be not greater than M, and K may be a positive integer.

In this way, using the heap sort algorithm for Top-K triple filtering may reduce computational complexity and be suitable for hotspot identification in large-scale data scenarios. The min-heap structure can dynamically maintain the Top-K triples during the data traversal process without needing to wait for the traversal to complete before performing global sorting, significantly improving processing efficiency. At the same time, by always retaining the largest K elements, the min-heap may avoid storing all the data, thus reducing memory consumption.

In some embodiments, identifying the sustained hotspot external link based on the potential hotspot triple by incorporating the counter values of the current time period and previous M historical time periods may include: calculating the sum or weighted average of the counter values of the same triple within the current time period and the previous M historical time periods; and when the sum or weighted average of the counter values exceeds a sustained popularity threshold, identifying this triple as the sustained hotspot external link.

Here, the weighted average may refer to assigning a weight to each value when averaging a set of values, adjusting the contribution of each value according to the magnitude of the weight. In an embodiment of the present disclosure, weights may be adjusted according to time order, thereby reflecting the dynamic change trend of the hotspot. Here, the weight may a parameter used in the weighted average calculation to represent the importance of counter values in different time periods. The specific allocation of weights may be adjusted according to business needs.

In an embodiment of the present disclosure, the counter value of the same triple within the current time period and the previous M historical time periods may first be obtained from the third-level cache. The counter value within each time period may be the accumulated number of accesses for this triple within the corresponding time segment. Subsequently, the sum or weighted average of the counter values may be calculated. Illustratively, the counter values within all time periods may be directly accumulated to calculate the total number of accesses, thus obtaining the sum of the counter values. Further, a weighted calculation may be performed on the counter values of each time period according to set weights to obtain the weighted average of the counter values. Particularly, the weights may be allocated dynamically.

Here, the sustained popularity threshold may refer to a preset fixed or dynamic value used to distinguish between an ordinary hotspot and a sustained hotspot. In an embodiment of the present disclosure, when the sum or weighted average of the counter values of a triple exceeds this sustained popularity threshold, the triple may be identified as the sustained hotspot external link. Particularly, the setting of the sustained popularity threshold may be usually based on historical statistical data and may vary depending on dimensions such as area or operation type.

In an embodiment of the present disclosure, the calculated sum or weighted average of the counter values may be compared with a preset sustained popularity threshold. If the sum or weighted average of the counter values exceeds the sustained popularity threshold, the triple may be identified as the sustained hotspot external link. Conversely, if the sum or weighted average of the counter values does not exceed the sustained popularity threshold, the triple may be ignored.

In this way, by incorporating the counter value of the current time period and the counter values of the previous M historical time periods, and through the calculation of the weighted average, it is possible to effectively identify hotspot external links with sustained popularity. The weighted average calculation method may take into account both recent and historical data, avoiding misjudgment of hotspots based solely on short-term traffic spikes from current time period data. At the same time, by highlighting the importance of recent data through weight allocation, it is possible to ensure that hotspot identification has real-time and dynamic characteristics. The setting of the sustained popularity threshold can provide a flexible judgment standard, which can be adjusted according to specific business scenarios, thereby adapting to hotspot identification needs for different areas, operation types, or time periods.

In some embodiments, in the weighted average, the weight of a recent time period may higher than that of a previous time period.

Here, the recent time period may refer to a time segment that is current or close to the present, and the previous time period may refer to a historical time segment farther from the current time. Particularly, data from the recent time period may usually reflect the latest dynamics of user behavior and be a key focus for hotspot identification, and data from the previous time period may be used to analyze long-term trends but has a smaller impact on a real-time hotspot.

In an embodiment of the present disclosure, the weights may be assigned to each time period based on the principle that the recent time period has a higher weight than the previous time period. Illustratively, time periods may be arranged in chronological order, with the weight of the current time period set to 1, and for each preceding time period traced back, the corresponding weight gradually decreases until the weight becomes 0.

In this way, by assigning a higher weight to the recent time period in the weighted average calculation, greater attention can be paid to the latest dynamics of user behavior, avoiding excessive reliance on historical data in hotspot identification. Furthermore, the high weight of the recent time period can ensure the real-time response capability for hotspot external links, while the low weight of the previous time period can provide historical data support, avoiding misjudgment caused by short-term traffic spikes.

In some embodiments, identifying the sustained hotspot external link based on the potential hotspot triple by incorporating the counter values of the current time period and previous M historical time periods may include: obtaining the counter values of the same triple within the current time period and the previous M historical time periods; inputting the counter values as features into a pre-trained machine learning model; and predicting the sustained hotspot external link by using the machine learning model.

In an embodiment of the present disclosure, the counter values of the same triple within the current time period and previous M historical time periods may be obtained from the third-level cache. These counter values may represent the number of user accesses or operation frequency for this external link, and may be arranged in chronological order to form time series data.

Here, the pre-trained machine learning model may refer to a model that has been trained learned from historical data, and is capable of outputting a prediction result based on experience or rules when input data is provided. In an embodiment of the present disclosure, the pre-trained model may be typically designed for hotspot identification tasks and can predict whether a certain triple is a sustained hotspot based on the time series of counter values, trends, and other relevant features.

In an embodiment of the present disclosure, the collated time series data may be input into the pre-trained machine learning model, so that the model may predict whether the triple belongs to a sustained hotspot based on the patterns learned during training. In this way, the pre-trained machine learning model can learn complex features and time series patterns of counter values, avoiding potential misjudgments or omissions that may occur with simple rule-based methods. Through the rapid prediction capability of the pre-trained machine learning model, the sustained hotspot external link can be judged in real-time during large-scale data processing, without consuming significant time on complex calculations or manual rule design, thereby improving response speed.

In some embodiments, outputting the identification result of the hotspot external link may include: collating the identification result of the hotspot external link based on area to form an area-based hotspot list; and based on a preset area priority configuration, performing filtering or weighted sorting on the area-based hotspot list and then outputting the area-based hotspot list.

Here, the area-based hotspot list may refer to classifying and collating the identification results of hotspot external links according to the area dimension, forming a set of hotspot external links with geographical attributes. In an embodiment of the present disclosure, the area-based hotspot list can provide a regional browse of hotspots.

In an embodiment of the present disclosure, after identifying the hotspot external link, each hotspot external link may be categorized into the corresponding area based on the user's geographical location information during access. Illustratively, the user's geographical location information may include the IP address, browser language settings, or user's area attribute tags. Subsequently, the area-based hotspot list may be generated based on the categorization results. Particularly, each area may have an independent data set of hotspot external links, which may include the hotspot identification results.

Here, the preset area priority configuration may refer to a pre-defined set of rules used to determine the processing priority of hotspot data for different areas. In an embodiment of the present disclosure, the preset area priority configuration may be set based on factors such as business needs, traffic distribution, activity strategies and the like.

In an embodiment of the present disclosure, based on the preset area priority, it is possible to choose to process or output only hotspot lists for certain higher-priority areas, while ignoring hotspot external links for lower-priority areas. Subsequently, weighted sorting can be performed on the hotspot external links in the area-based hotspot lists according to the area priority. Illustratively, for hotspot external links corresponding to higher-priority areas, the popularity value may be multiplied by an amplification weight, and the external links in the hotspot list may be sorted in descending order by using the weighted popularity value, ensuring that hotspot external links with higher priority may be output first.

In this way, by collating the identification result of the hotspot external link based area and performing filtering or weighted sorting based on the preset area priority configuration, attention can be paid to the behavioral habits of users in different areas and the distribution characteristics of hotspot external links, thereby achieving more precise hotspot management and optimization. The preset area priority configuration can have high flexibility and can be dynamically adjusted according to business needs within different time periods. The dynamic nature of the priority configuration can ensure that computing and display resources can be prioritized for key areas, thus optimizing the utilization efficiency of system resources.

In some embodiments, the method for identifying a hotspot external link may further include: periodically cleaning up expired counter data in the multi-level cache; when an error occurs during cache reading/writing or data processing, recording an exception log containing an error type and cache level; and performing performance monitoring and optimization based on the exception log.

In an embodiment of the present disclosure, the first-level cache can periodically and automatically clean up expired data based on a preset expiration strategy through memory management strategies. The second-level cache can periodically and automatically clean up data through memory management strategies after the third-level cache periodically queries the data. For data in the third-level cache, scheduled tasks (e.g., a daily cleanup script) may be performed for scanning for and deleting expired data.

Here, the error type may refer to the type of exception caused by the failure of cache reading/writing or data processing operations during a process for identifying a hotspot external link. In an embodiment of the present disclosure, the error type may include reading/writing error, data format error, timeout error, connection error, etc.

Here, the cache level may refer to the specific storage layer within the multi-level cache used in the method for identifying a hotspot external link. In an embodiment of the present disclosure, the cache level may at least include a first-level cache, a second-level cache, and a third-level cache.

Here, the exception log may refer to a log file containing error information, used for tracking and analyzing exceptional situations. In an embodiment of the present disclosure, the exception log may include a timestamp, error type, cache level, detailed description, etc.

In an embodiment of the present disclosure, an error capture mechanism may be added during cache reading/writing or data processing. When an operation fails, the exception information may be captured, and this exception information may be then written into an exception log file. Particularly, the exception log may be stored in a file system, database, or a dedicated monitoring system.

In an embodiment of the present disclosure, the exception log may be analyzed periodically to count the frequency, type, and distribution of errors. Illustratively, the number of errors at different cache levels may be counted, and high-frequency error types and causes thereof (fox example, an error caused by specific time periods or operations) may be analyzed. Furthermore, a monitoring tool may be used to monitor the exception log in real-time and set an alert rule. Further, an optimization measure may be taken based on the log analysis result. Illustratively, if the first-level cache overflows frequently, the memory capacity may be increased; if connection to the second-level cache times out, the network bandwidth may be increased or the cache connection pool strategy may be optimized; and if write latency of the third-level cache is high, disk Input/Output (I/O) performance may be optimized or stored data may be compressed. Particularly, the logs may continue to be monitored after implementing optimization measures to ensure the problem is resolved.

In this way, by periodically cleaning up cache data, expired data may be prevented from occupying resources, improving the cache hit rate and operational efficiency, thereby ensuring the real-time performance and accuracy of the hotspot external link identification. Recording exception logs may help development and operation personnel quickly obtain exception information, including error type, cache level, and detailed description, thus accurately finding out the root cause of problems and reducing troubleshooting time. By analyzing the exception log, potential performance bottlenecks can be identified and timely optimization measures can be taken, thereby reducing failure rates and improving overall stability. The exception log may provide a reliable data foundation for performance monitoring and optimization. By periodically analyzing logs, trend problems in long-term operation may be discovered and optimized accordingly.

In some embodiments, the method for identifying a hotspot external link may further include: continuously writing the identification result of the hotspot external link and a popularity value associated thereto into a long-term aggregation cache structure based on a circular buffer, to maintain historical popularity data for most recent hours; and generating a historical popularity report reflecting change trend of popularity of the hotspot external link based on the data in the long-term aggregation cache structure.

Here, the circular buffer may refer to a fixed-size queue data structure in which old data may be overwritten in a circular manner when it reaches full capacity. In an embodiment of the present disclosure, the circular buffer may be used to store hotspot external links and popularity data thereof for the most recent hours, and automatically discard old data that falls outside a time range.

Here, the long-term aggregation cache structure may refer to a storage mechanism implemented based on the circular buffer. In an embodiment of the present disclosure, the long-term aggregation cache structure can aggregate and maintain the historical popularity data of hotspot external links, and can store data within a certain time range.

In an embodiment of the present disclosure, a fixed-size storage space may first be allocated for the popularity data of the hotspot external link. Subsequently, the identification result of the hotspot external link and a popularity value associated thereto may be written into the circular buffer in real time. Exemplarily, during the writing process, if the circular buffer is not full, writing may proceed directly; and if the circular buffer is full, the earliest written data may be overwritten, so as to achieve circular overwriting. Furthermore, aggregation calculation may be performed on the hotspot data in the circular buffer. Exemplarily, statistics may be performed on data in the buffer based on hour to calculate indicators such as the average popularity and maximum popularity per hour. Data for the same external link may also be aggregated to generate popularity change data for each external link. In particular, data that falls outside the time range of the buffer may also be periodically cleaned up to ensure that the cache structure only maintains popularity information for the most recent hours.

Here, the historical popularity report may refer to a visual or structured data output generated based on the data in the long-term aggregation cache structure. In an embodiment of the present disclosure, the historical popularity report may reflect the historical change trend of the popularity of the hotspot external link.

In an embodiment of the present disclosure, the historical change trend of the popularity of the hotspot external link may be analyzed based on the data in the long-term aggregation cache structure. Exemplarily, a popularity growth rate may be calculated based on current popularity and historical popularity, and a popularity peak and corresponding time point may also be identified based on popularity values within a recent period. Subsequently, the analysis result may be collated as structured data or chart report. Exemplarily, popularity may be sorted based on time to obtain a popularity change curve for the hotspot external link, showing the dynamic change of popularity over time. A key statistical indicator for each hotspot external link, such as average popularity, maximum popularity, and change trend, may also be calculated.

In this way, the fixed capacity and circular overwriting mechanism of the circular buffer can effectively limit storage space usage, avoiding the unlimited accumulation of historical data, while ensuring the cache always retains popularity data of the hotspot external link for the most recent hours, thereby offering high storage efficiency and real-time performance. The long-term aggregation cache structure may dynamically maintain the historical popularity data of the hotspot external link and update popularity change statistics in real time, enabling quick capture of popularity peaks or trend changes of hotspot external links, thereby adapting to the dynamic nature of hotspot data. By generating historical popularity reports, it is possible to clearly reflect the change trends of popularity of the hotspot external links, supporting further hotspot prediction and analysis. For example, identifying an external link with continuously rising popularity may provide a basis for traffic scheduling or content recommendation.

In some embodiments, the method for identifying a hotspot external link may further include: determining popularity information, duration, and popularity trend based on the identification result of the hotspot external link and/or the historical popularity report; and collating the popularity information, duration, and popularity trend into broadcast information, and pushing the broadcast information to a target terminal.

Here, the popularity information may refer to the core data of a hotspot external link within a specific time range. In an embodiment of the present disclosure, the popularity information may include the popularity value and a statistical indicator such as average popularity and maximum popularity, which may reflect the level of attention on an external link.

Here, the duration may refer to the time range during which a particular hotspot external link remains in a hotspot state. In an embodiment of the present disclosure, the duration may help assess the stability and persistence of a hotspot.

Here, the popularity trend may reflect the dynamic characteristics of the popularity change of a hotspot external link. In an embodiment of the present disclosure, the popularity trend may describe the increase or decrease of the popularity of a hotspot external link over time.

In an embodiment of the present disclosure, relevant data may first be extracted from the identification result of hotspot external links and the historical popularity report. Exemplarily, the current popularity value and basic statistical indicator may be extracted from the identification result, and popularity change data over a period of time may also be extracted from the historical popularity report. Subsequently, the current popularity can be obtained by directly reading the popularity data from the identification result of the hotspot external links, the average popularity may be calculated by averaging data from the historical popularity report, and the maximum popularity may be obtained by identifying the popularity peak from the historical popularity report. The current popularity, average popularity, and maximum popularity can then be integrated into popularity information. Next, the duration may be recorded starting from the time when an external link was first identified as a hotspot, and the duration may be determined by calculating a difference between the current time and the start time. Particularly, for the external link identified as hotspots multiple times, time period records may be maintained and aggregated to obtain the cumulative duration. Finally, the change in popularity over time may be analyzed based on the time-series data in the historical popularity report, thereby deriving the popularity trend. Exemplarily, if the growth rate of the popularity value is positive and increasing, it can be determined as an upward trend; if the growth rate of the popularity value is negative and decreasing, it can be determined as a downward trend; and if the popularity value changes little and remains within a certain range, it can be determined as a stable trend.

Here, the broadcast information may refer to collated hotspot data used to push information related to the hotspot external link to the target terminal. In an embodiment of the present disclosure, the broadcast information may include the external link identifier, area code, popularity value, duration, trend analysis, etc.

In an embodiment of the present disclosure, information such as the external link identifier, area code, popularity value, duration, trend analysis, etc. may be collated as the broadcast information. Exemplarily, the broadcast information may be presented in the form of structured data or visual reports, ensuring that the target terminal can parse it quickly. Finally, the broadcast information may be pushed to the target terminal via system notification, API interface, or message queue. Particularly, the target terminal may be a monitoring system, content recommendation platform, advertising delivery system, or user interface, depending on business needs.

In this way, timely pushing structured hotspot analysis data to the target terminal can enable low-latency flow of hotspot status information from the system to the business side, greatly shortening the path from perception to decision-making. The broadcast information may integrate multi-dimensional data such as popularity value, duration, and trend analysis, providing a complete characterization of the dynamic properties of the hotspot external link, thereby offering deep data support for business units to conduct impact assessments and formulate strategies. Through quantitative analysis of the hotspot lifecycle, it is possible to assist business units in predicting the development stage of hotspots, thereby providing a crucial basis for accurately and efficiently allocating computing and bandwidth resources.

In some embodiments, the method for identifying a hotspot external link can quickly identify the hotspot external link with the highest current page browsing at a minute-level granularity, while significantly reducing computational and storage costs. The method can achieve efficient data management and real-time hotspot monitoring by narrowing down the data range step by step and dynamically filtering, providing business operations with accurate hotspot content broadcast support.

Specifically, when a user performs an action (e.g., browsing, playing, or saving) on external link B in area C, a corresponding dimension counter for (B_C_action) may be incremented by one. This may constitute the first-level cache, which records basic access data for all external links under different areas and operation types, with a data scale being of “number of external links ×number of areas ×number of actions”. To ensure that the count results can reflect the latest user action, a new counter may be created every minute to record the data for this minute. This design can ensure the precision of the counting time range and real-time updates at a minute level.

Furthermore, when the value of a certain counter in the first-level cache exceeds a preset threshold, the relevant information of this counter may be stored in the second-level cache. The second-level cache may be implemented using Redis's Sorted Set (also known as zset), specifically storing data for external link in area C with a certain type of action frequency high enough to warrant attention. By setting a reasonable threshold, the data scale of the second-level cache may be significantly reduced to one ten-thousandth or even one hundred-thousandth of the first-level cache, thereby significantly lowering the cost of subsequent sorting and calculation.

Furthermore, the second-level cache may be queried periodically every minute to filter out the external link, area, and operation type that need attention, and this data may be then retrieved from the first-level cache and written into the third-level cache. The third-level cache may also use Redis's zset data structure, primarily used for aggregation and sorting of minute-level hotspot content. At this point, hotspot content may be sorted in descending order based on popularity values, allowing for the quick identification of the most popular triple (external link, area, action) within the current minute. The minute-level hotspot list can provide real-time data support for subsequent analysis and business decisions.

Even further, by jointly querying the third-level cache within the most recent minutes, is possible to further analyze which triple (external link, area, action) consistently remain at the top of the hotspot list within a certain time range. For these pieces of content that have a long duration and high popularity ranking, they may be regarded as hotspot external links, and their popularity status may be broadcasted. In this process, not only the basic popularity information of the hotspot external links may be provided, but also the duration of the hotspot and its popularity trend (e.g., upward, downward, or stable trends) may be recorded. This data can provide an important basis for traffic control, content recommendation, or advertising optimization in business scenarios.

Finally, to further support long-term trend analysis, an additional Redis zset data structure may be maintained to store and aggregate triple (external link, area, action) data for the most recent hours while generating the third-level cache. Through this data structure, a multi-hour dimensional popularity report may be generated, comprehensively reflecting the historical dynamics and development trends of hotspot content, thereby providing richer decision-making references for the business.

In some embodiments, the data granularity of the first-level cache may be designed to be minute-level, meaning that a new counter for (B_C_action) may be generated every minute to record the number of occurrences of the corresponding action (e.g., browsing, playing, or saving) for external link B in area C during this minute. Counters for different minutes may be independent of each other and have no association. This may ensure that the time range of the cached data is clear, facilitating subsequent hotspot identification and data filtering. Particularly, to optimize storage space usage, an expiration time can be set for each {B_C_action} counter. Specifically, when the counter is generated, a Time-to-Live (TTL) for this counter in Redis may be set. This expiration time may ensure that the counter data may be automatically deleted after being stored for a certain period (e.g., a few minutes), without requiring additional cleanup operation. In this way, each counter may only occupy cache space during the effective period of its data, and may be then automatically cleared by Redis, freeing up storage resources. By setting a reasonable expiration time, the maximum space usage of the cache may be adjusted according to business needs and resource capacity, ensuring performance balance.

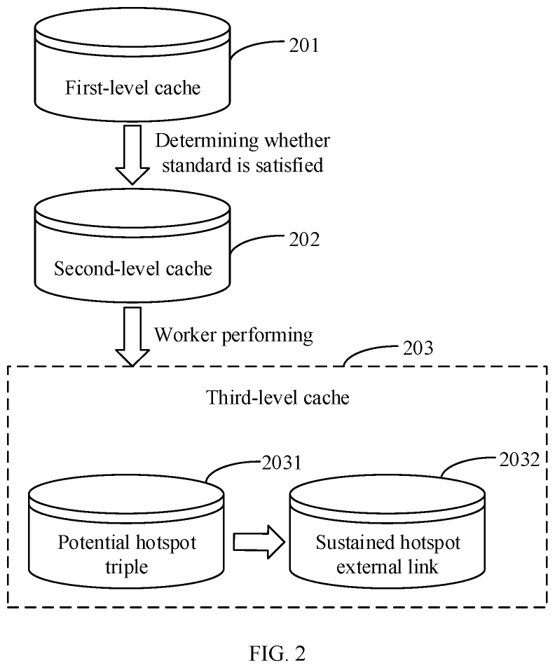

FIG. 2 shows a schematic structural diagram of a three-level cache according to an embodiment of the present disclosure. As shown in FIG. 2, the three-level cache may include a first-level cache 201, a second-level cache 202, and a third-level cache 203. In some embodiments, the third-level cache 203 may include a potential hotspot triple 2031 and a sustained hotspot external link 2032.

Specifically, the first-level cache 201 may be used to record basic data for all external links under different areas and user actions (e.g., browsing, saving, or playing). The main function of the first-level cache 201 may be to count every online request from users and store these counts with minute-level granularity. The data scale of the first-level cache 201 may be relatively large, covering all external links, areas, and actions, while an expiration time is set to ensure data may be automatically deleted after a few minutes, thereby reducing storage space occupation.

Further, the second-level cache 202 may be used to filter key data from the first-level cache 201. Specifically, when a counter in the first-level cache 201 exceeds a set threshold, the information of this counter may be written into the second-level cache 202. Through threshold filtering, the second-level cache 202 can effectively reduce the data scale, retaining only data that may potentially become hotspots, thereby significantly reducing resource consumption for storage and computation.

Furthermore, the third-level cache 203 may be used for further aggregation and tracking of data for hotspot external links. In some embodiments, the potential hotspot triple 2031 may be used to store data for the external link identified as having a hotspot tendency within the current time period, including external link identifier, area identifier, and operation type (i.e., a triple structure). This data may mainly originate from the second-level cache 202 and be generated by sorting and analyzing data within the current minute, reflecting the preliminary hotspot trends within this time period. The sustained hotspot external link 2032 may be used to store external links determined as hotspots after continuous tracking. By analyzing the popularity changes of potential hotspot triples over multiple minutes or longer time ranges, the external link that consistently remains at the top can be identified and marked as a sustained hotspot.

In some implementations, when a user performs an action such as browsing, saving, or playing on an external link, a corresponding interface may call a counting service to report information including the external link identifier, area identifier, and operation type. The counting service may first operate on the first-level cache 201, synchronously incrementing the corresponding counter value by one based on the current external link, area, and operation type. This level of cache, with minute-level granularity, may record basic access data for all external links within the current minute, ensuring real-time statistics on the latest dynamics of hotspot content.

After completing the count update for the first-level cache 201, an asynchronous task may be further initiated to update the second and third-level caches 202 and 203 step by step, thereby filtering and aggregating key data. Specifically, when the value of a counter in the first-level cache 201 exceeds a set threshold, the relevant data for this hotspot external link may be written into the second-level cache 202. The second-level cache 202 may be primarily used to identify the external link with currently high access volume, significantly reducing the data scale, thereby lowering the resource requirements for subsequent calculation and storage. Subsequently, based on, hotspot data may be extracted from the second-level cache 202 every minute according to a time scheduling mechanism, and the aggregated and sorted results of the hotspot external link may be written into the third-level cache 203 by incorporating with the latest records from the first-level cache 201. The third-level cache 203 may store a minute-level list of hotspots, facilitating the rapid identification of the hottest external link within this minute.

At the same time, the third-level caches 203 within the most recent minutes may be regularly queried jointly. By analyzing hotspot content that has a long duration and ranks high in popularity, the sustained hotspot external link may be identified. For this hotspot data, the key indicator such as popularity information, duration, trend change, etc. may be further calculated, and the analysis result may be pushed to the business side through hotspot broadcast. The hotspot broadcast content may include the external link identifier, area code, operation type, popularity value, hotspot duration, and trend analysis for providing comprehensive and reliable data support. Additionally, a long-term cache may be maintained to aggregate hotspot data within several hours, thereby generating a multi-time dimension historical trend report, so as to provide deeper decision-making basis for the business.

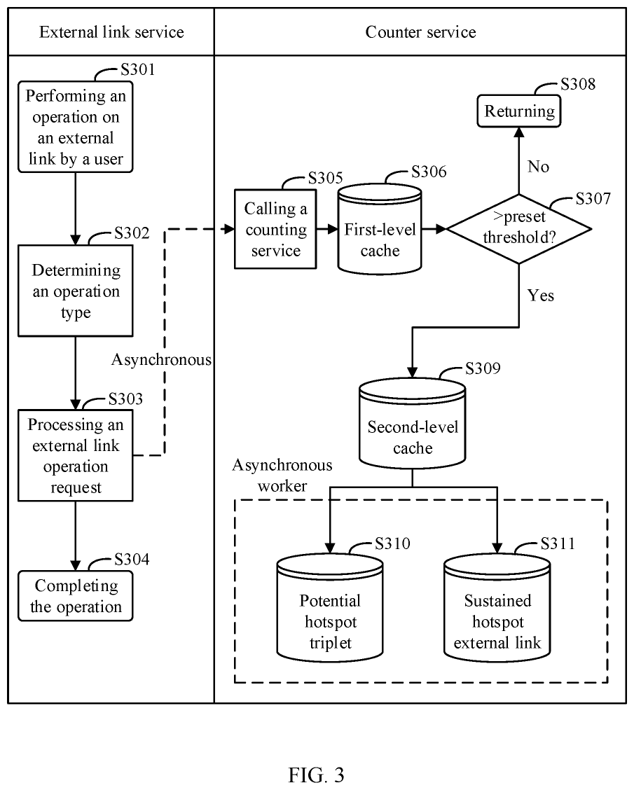

FIG. 3 shows another schematic flowchart of a method for identifying a hotspot external link according to an embodiment of the present disclosure. As shown in FIG. 3, the method for identifying a hotspot external link may include:
S301: Performing an operation on an external link by a user, that is, the user may interact with the external link to trigger a counting request for an external link service.
S302: Determining an operation type, that is, a specific operation type may be determined based on the operation of the user, wherein the operation type may include external link browsing, external link saving, external link playback, etc.
S303: Processing an external link operation request, that is, routine business processing logic (e.g., such as recording user actions, updating playback status, etc.) may be completed by using the external link service.
S304: Completing the operation, that is, the routine business processing logic of the external link service may end, and the user request has been satisfied.
S305: Calling a counting service, that is, the external link service may invoke the counting service through an interface, to transfer the external link identifier, the area identifier, and action information to the counting service.
S306: Updating a first-level cache, that is, the counting service may operate on the first-level cache based on these parameters, incrementing a corresponding counter value by one, which may be implemented by using an INCR command.
S307: Determining whether the counter value exceeds a preset threshold, that is, the counting service may check whether the counter value in the first-level cache exceeds the preset threshold. If the counter value does not reach the preset threshold, proceed to S308; and if the counter value exceeds the preset threshold, proceed to S309.
S308: Returning, that is, when the counter value does not reach the preset threshold, the counting service may directly return to the external link service without further processing, indicating that the action did not trigger the hotspot identification logic, and the process ends.
S309: Updating a second-level cache, that is, if the counter value exceeds the preset threshold, the counting service may write data of the hotspot external link into the second-level cache, storing the data in Redis's Sorted Set, which may be implemented using a ZADD command.
S310: Updating a potential hotspot triplet, that is, when the second-level cache detects a hotspot external link, an asynchronous worker task may store data of this hotspot external link into the potential hotspot triplet in a third-level cache, which may be implemented using a ZADD command.
S311: Updating a sustained hotspot external link, that is, the asynchronous worker task may also store the hotspot external link confirmed through continuous tracking into the sustained hotspot external link in the third-level cache, which may be implemented using a HSET command.

It should be understood that the schematic diagrams shown in FIGS. 2 and 3 are illustrative and not restrictive, and they may be extendable. Those skilled in the art can make various obvious changes and/or substitutions based on examples in FIGS. 2 and 3, and the resulting technical solutions still fall within the scope of the present disclosure.

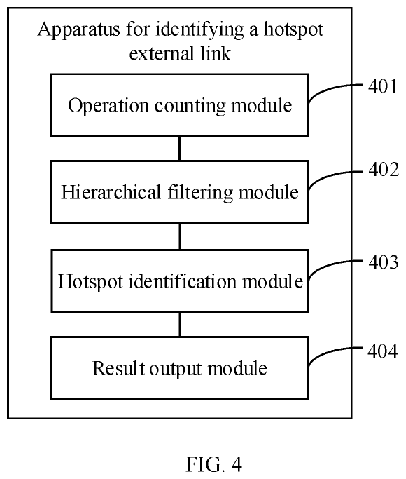

The present disclosure provides an apparatus for identifying a hotspot external link. As shown in FIG. 4, the apparatus may include: an operation counting module 401, configured to, in respond to an operation of a user on an external link, obtain an external link identifier, an area code of the user and an operation type, to construct a triplet counter, each triple counter corresponding to a dimension of (external link, area, operation type); a hierarchical filtering module 402, configured to perform hierarchical processing and filtering on the triple counter via multi-level cache, to identify a potential hotspot triple; a hotspot identification module 403, configured to identify a sustained hotspot external link based on the potential hotspot triplet by incorporating counter values of a current time period and previous M historical time periods, where M may be a positive integer; and a result output module 404, configured to output an identification result of the hotspot external link.

In some embodiments, the multi-level cache may include at least two levels of cache. some embodiments, the hierarchical filtering module 402 may include: a preliminary filtering submodule, configured to perform updating and preliminary filtering on the triplet counter in the first-level cache according to a first predetermined strategy to obtain a first candidate set; a secondary filtering submodule, configured to perform further filtering on the first candidate set in a next-level cache according to a second predetermined strategy to obtain a second candidate set with a data volume smaller than that of the first candidate set; and a potential hotspot determination submodule, configured to determine the potential hotspot triplet based on the second candidate set.

In some embodiments, the at least two levels of cache may specifically include a first-level cache, a second-level cache, and a third-level cache. In some embodiments, the hierarchical filtering module 402 may include: a first-level counting submodule, configured to update a counter value with a minute-level time period granularity in the first-level cache, and set a minute-level expiration time for each counter; a second-level filtering submodule, configured to store corresponding information into the second-level cache when the counter value in the first-level cache exceeds a preset threshold; and a third-level sorting submodule, configured to periodically query the second-level cache in the third-level cache, and sort the obtained triplets to filter for the potential hotspot triplet.

In some embodiments, the first-level counting submodule may be configured to: in response to the operation of the user on the external link, determine a current time period based on an operation time, where the current time period may use minute as the time period granularity; and increment a value of a corresponding triple counter based on the current time period.

In some embodiments, the corresponding information may include a triplet identifier and a counter value.

In some embodiments, the preset threshold may be dynamically set based on historical hotspot data statistics, and differentiated thresholds may be set for different areas or operation types.

In some embodiments, the third-level sorting submodule may be configured to use an asynchronous query with a minute interval to periodically query the second-level cache in the third-level cache.

In some embodiments, the third-level sorting submodule may be also configured to use a heap sort algorithm to sort counter values in descending order to obtain the Top-K potential hotspot triples.

In some embodiments, the hotspot identification module 403 may include: a historical calculation submodule, configured to calculate the sum or weighted average of the counter values for the same triplet in the current time period and the previous M historical time periods; and a threshold comparison submodule, configured to identify the triple as a sustained hotspot external link when the sum or weighted average of the counter values exceeds a sustained hotspot threshold.

In some embodiments, in the weighted average, the weight of a recent time period may higher than that of a previous time period.

In some embodiments, the hotspot identification module 403 may include: a value acquisition submodule, configured to obtain the counter values of the same triplet within the current time period and the previous M historical time periods; a model prediction submodule, configured to input the counter values as features into a pre-trained machine learning model; and a hotspot prediction submodule, configured to use the machine learning model to predict the sustained hotspot external link.

In some embodiments, the result output module 404 may include: a dimension splitting submodule, configured to arrange the identification result of the hotspot external link based on area to form an area-based hotspot list; and a result sorting submodule, configured to perform filtering or weighted sorting on the area-based hotspot list based on a preset area priority configuration, and output the area-based hotspot list.

In some embodiments, the apparatus for identifying a hotspot external link may further include: an expiration cleaning module (not shown in FIG. 4), configured to periodically clean up expired counter data in the multi-level cache; an exception recording module (not shown in FIG. 4), configured to record an exception log containing an error type and cache level when an error occurs during cache reading/writing or data processing; and a monitoring and optimization module (not shown in FIG. 4), configured to perform performance monitoring and optimization based on the exception log.

In some embodiments, the apparatus for identifying a hotspot external link may further include: a data maintenance module 408 (not shown in FIG. 4), configured to continuously write the identification result of the hotspot external link and a popularity value associated thereto into a long-term aggregation cache structure based on a circular buffer, to maintain historical popularity data for most recent hours; and a report generation module 409 (not shown in FIG. 4), configured to generate a historical popularity report reflecting change trend of popularity of the hotspot external link based on the data in the long-term aggregation cache structure.

In some embodiments, the apparatus for identifying a hotspot external link may further include: an information collation module (not shown in FIG. 4), configured to determine popularity information, duration, and popularity trend based on the identification result of the hotspot external link and/or the historical popularity report; and an information broadcast module 411 (not shown in FIG. 4), configured to collate the popularity information, duration, and popularity trend into broadcast information, and push the broadcast information to a target terminal.

For detailed descriptions of the specific functions and examples of each module and submodule of the apparatus in the embodiments of the present disclosure, reference may be made to the corresponding steps in the above method embodiments, which will not be repeated here.

The apparatus for identifying a hotspot external link in the embodiments of the present disclosure may record the specific access dimensions of the external link through triplet counters, and filter potential hotspots in combination with a multi-level cache, thereby improving the accuracy of hotspot external link identification. By adopting a multi-level cache strategy, high-frequency data within a short period may be stored in the first-level cache, which may reduce the computational pressure on global data and significantly enhance performance. Hotspots may be quickly identified within minute-level time periods, ensuring real-time output of results and meeting the business requirements for timeliness. By incorporating data from the current time period and historical time periods, the continuous change trend of the hotspot external link can be dynamically tracked, enabling timely processing and analysis support for hotspot resources. The output identification results of hotspots may provide an important basis for business decision, thereby facilitating timely measures to address the business impact brought by the hotspot external link.

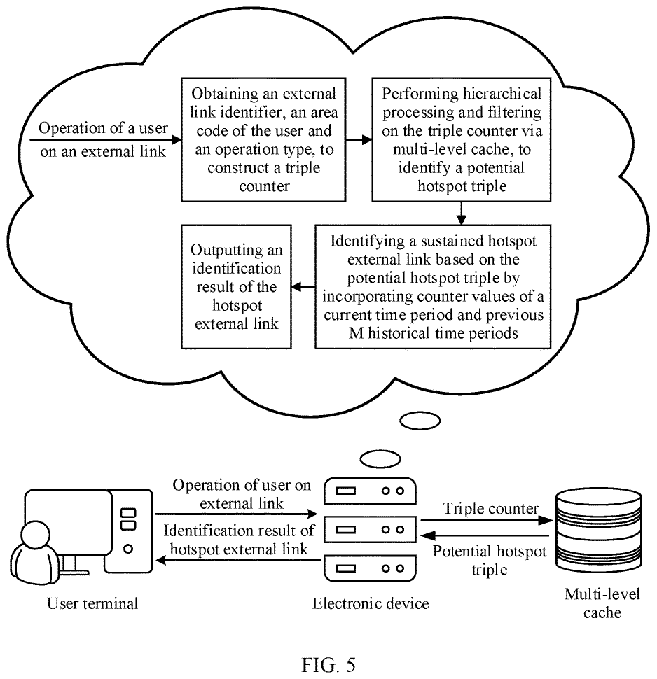

The present disclosure may provide a schematic scenario diagram of a method for identifying a hotspot external link, as shown in FIG. 5.

As mentioned above, the method for identifying a hotspot external link provided by the present disclosure may be applied to electronic devices. Electronic devices may be intended to represent various forms of digital computers, such as laptops, desktops, workstations, personal digital assistants, servers, blade servers, mainframes, and other suitable computers.

Specifically, the electronic device may perform the following operations:

In response to an operation of a user on an external link, obtaining an external link identifier, an area code of the user and an operation type, to construct a triple counter, where each triple counter may correspond to a dimension of (external link, area, operation type); Performing hierarchical processing and filtering on the triple counter via multi-level cache, to identify a potential hotspot triple; identifying a sustained hotspot external link based on the potential hotspot triple by incorporating counter values of a current time period and previous M historical time periods, where M may be a positive integer; and outputting an identification result of the hotspot external link.

It should be understood that the scenario diagram shown in FIG. 5 is illustrative and not restrictive. Those skilled in the art can make various obvious changes and/or substitutions based on the example in FIG. 5, and the resulting technical solutions still fall within the scope of the present disclosure.

In the technical solution of the present disclosure, the acquisition, storage, and application of user's personal information involved are all in compliance with the provisions of relevant laws and regulations, and do not violate public order and good customs.

According to the embodiments of the present disclosure, the present disclosure also provides an electronic device, a readable storage medium, and a computer program product.

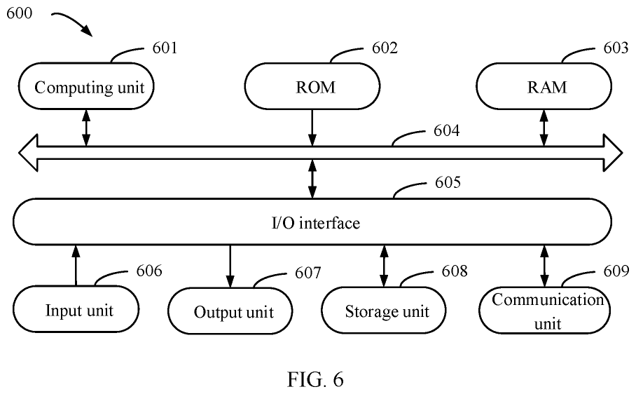

FIG. 6 shows a schematic structural block diagram of an electronic device 600 for implementing the method for identifying a hotspot external link according to an embodiment of the present disclosure. The electronic device may be intended to represent various forms of digital computers, such as laptops, desktops, workstations, personal digital assistants, servers, blade servers, mainframes, and other suitable computers. The electronic device may also represent various forms of mobile devices, such as personal digital assistants, cellular phones, smart phones, wearable devices, and other similar computing devices. The components shown herein, their connections and relationships, and their functions may be merely examples and be not intended to limit the implementations of the disclosure described and/or claimed herein.

As shown in FIG. 6, the device 600 may include a computing unit 601, which can execute various appropriate actions and processes according to a computer program stored in a read-only memory (ROM) 602 or a computer program loaded from a storage unit 608 into a random access memory (RAM) 603. In RAM 603, various programs and data required for the operation of the device 600 may also be stored. The computing unit 601, ROM 602, and RAM 603 are connected to each other via a bus 604. An input/output (I/O) interface 605 may be also connected to the bus 604.

Multiple components in the device 600 may be connected to the I/O interface 605, and those components may include: an input unit 606, such as a keyboard, a mouse, etc.; an output unit 607, such as various types of displays, speakers, etc.; a storage unit 608, such as a magnetic disk, an optical disk, etc.; and a communication unit 609, such as a network card, a modem, a wireless communication transceiver, etc. The communication unit 609 may allow the device 600 to exchange information/data with other devices via a computer network such as the Internet and/or various telecommunication networks.

The computing unit 601 may be various general-purpose and/or special-purpose processing components with processing and computing capabilities. Some examples of the computing unit 601 may include, but not limited to, a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, etc. The computing unit 601 may execute the various methods and processes described above, such as the method for identifying a hotspot external link. For example, in some embodiments, the method for identifying a hotspot external link may be implemented as a computer software program tangibly embodied on a machine-readable medium, such as the storage unit 608. In some embodiments, part or all of the computer program may be loaded and/or installed onto the device 600 via the ROM 602 and/or the communication unit 609. When the computer program is loaded into the RAM 603 and executed by the computing unit 601, one or more steps of the method for identifying a hotspot external link described above may be performed. Alternatively, in other embodiments, the computing unit 601 may be configured to execute the method for identifying a hotspot external link by any other suitable means (e.g., by means of firmware).

Various implementations of the systems and techniques described above herein may be implemented in digital electronic circuit systems, integrated circuit systems, field programmable gate arrays (FPGAs), application specific integrated circuits (ASICs), application-specific standard products (ASSPs), systems on chip (SOCs), complex programmable logic devices (CPLDs), computer hardware, firmware, software, and/or combinations thereof. These various implementations may include being implemented in one or more computer programs executable and/or interpretable in a programmable system including at least one programmable processor, and the programmable processor may be a special-purpose or general-purpose programmable processor, and be capable of receiving data and instructions from, and transmitting data and instructions to, a storage system, at least one input device, and at least one output device.

Program code for implementing the methods of the present disclosure may be written in any combination of one or more programming languages. These program codes may be provided to a processor or controller of a general-purpose computer, a special-purpose computer, or other programmable data processing apparatus, such that the program codes, when executed by the processor or controller, cause the functions/operations specified in the flowcharts and/or block diagrams to be implemented. The program codes may execute entirely in the machine, partly in the machine, partly in the machine and partly in a remote machine as different stand-alone software packages, or entirely in the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but not limited to, an electronic, magnetic, optical, electromagnetic, infrared or semiconductor system, apparatus or device, or any suitable combination thereof. More specific examples of a machine-readable storage medium may include an electrical connection based on one or more wirings, a portable computer disk, a hard disk, a random access memory, a read-only memory, an erasable programmable read-only memory (EPROM), a flash memory, an optical fiber, a portable compact disk read-only memory (CD-ROM), an optical storage device, a magnetic storage device, or any suitable combination thereof.

To provide interaction with a user, the systems and techniques described herein may be implemented in a computer, and the computer may include: a display device for displaying information to the user (e.g., a cathode ray tube (CRT) or liquid crystal display (LCD) monitor); and a keyboard and a pointing device (e.g., a mouse or a trackball) through which the user can provide input to the computer. Other kinds of devices may also be used to provide interaction with the user. For example, feedback provided to the user may be any form of sensory feedback (e.g., visual feedback, auditory feedback, or tactile feedback), and input from the user may be received in any form (including acoustic input, speech input, or tactile input).

The systems and techniques described herein may be implemented in a computing system that includes a back-end component (e.g., as a data server), a computing system that includes a middleware component (e.g., an application server), a computing system that includes a front-end component (e.g., a user computer including a graphical user interface or a web browser through which a user may interact with an implementation of the systems and techniques described herein), or a computing system that includes any combination of such back-end, middleware, or front-end components. The components of the system may be interconnected by any form or medium of digital data communication (e.g., a communication network). Examples of communication networks may include a local area network (LAN), a wide area network (WAN), and the Internet.

A computer system may include a client and a server. the client and server may be generally remote from each other and typically interact through a communication network. The relationship of client and server may be generated by a computer program running in a respective computer and having a client-server relationship with each other. The server may be a cloud server, a server in a distributed system, or a server integrated with blockchain.

It should be understood that the various forms of processes shown above may be used to rearrange, add, or delete steps. For example, the steps described in the present disclosure may be executed in parallel, sequentially, or in a different order, as long as the desired results of the technical solutions disclosed in the present disclosure can be achieved, and no limitation is imposed herein.

It should be understood that the various forms of processes shown above may be used to reorder, add, or delete steps. For example, the steps described in the present disclosure may be executed in parallel, sequentially, or in a different order, as long as the desired results of the technical solutions disclosed in the present disclosure can be achieved, and no limitation is imposed herein.

The above specific embodiments do not constitute a limitation on the protection scope of the present disclosure. It should be understood by those skilled in the art that various modifications, combinations, sub-combinations, and substitutions may be made according to design requirements and other factors. Any modification, equivalent replacement, and improvement made within the principle of the present disclosure shall be included within the protection scope of the present disclosure.

What is claimed is:

1. A method for identifying a hotspot external link, comprising:
in response to an operation of a user on an external link, obtaining an external link identifier, an area code of the user and an operation type, to construct a triple counter, wherein each triple counter corresponds to a dimension of (external link, area, operation type);
performing hierarchical processing and filtering on the triple counter via multi-level cache, to identify a potential hotspot triple;
identifying a sustained hotspot external link based on the potential hotspot triple by incorporating counter values of a current time period and previous M historical time periods, wherein M is a positive integer; and
outputting an identification result of the hotspot external link.

2. The method of claim 1, wherein the multi-level cache comprises at least two levels of cache, and
the hierarchical processing and filtering comprise:
in a first-level cache, performing updating and preliminarily filtering on the triple counter according to a first predetermined strategy to obtain a first candidate set;
in a next-level cache, performing further filtering on the first candidate set according to a second predetermined strategy to obtain a second candidate set with a data volume smaller than that of the first candidate set; and
determining the potential hotspot triple based on the second candidate set.

3. The method of claim 2, wherein the at least two levels of cache comprise a first-level cache, a second-level cache, and a third-level cache, and
the hierarchical processing and filtering comprise:
in the first-level cache, updating a counter value with a minute-level time period granularity, and setting a minute-level expiration time for each counter;
in a case where the counter value in the first-level cache exceeds a preset threshold, storing corresponding information into the second-level cache; and
in the third-level cache, periodically querying the second-level cache and sorting obtained triples to filter for the potential hotspot triple.

4. The method of claim 3, wherein in the first-level cache, the updating of the counter value with the minute-level time period granularity, comprises:
in response to the operation of the user on the external link, determining a current time period based on an operation time, wherein the current time period uses minute as the time period granularity; and
incrementing a value of a corresponding triple counter based on the current time period.

5. The method of claim 3, wherein the corresponding information comprises a triple identifier and a counter value.

6. The method of claim 3, wherein the preset threshold is dynamically set based on historical hotspot data statistics, and differentiated thresholds are set for different areas or operation types.

7. The method of claim 3, wherein in the third-level cache, the periodically querying of second-level cache, comprises:
periodically querying the second-level cache by using an asynchronous query with a minute interval in the third-level cache.

8. The method of claim 3, wherein the sorting of the obtained triples to filter for the potential hotspot triple, comprises:
sorting counter values in descending order by using a heap sort algorithm to obtain Top-K potential hotspot triples.

9. The method of claim 1, wherein the identifying of the sustained hotspot external link based on the potential hotspot triple by incorporating the counter values of the current time period and the previous M historical time periods, comprises:
calculating a sum or weighted average of counter values of the same triple within the current time period and the previous M historical time periods; and
in a case where the sum or weighted average of the counter values exceeds a sustained popularity threshold, identifying the triple as the sustained hotspot external link.

10. The method of claim 9, wherein in the weighted average, a weight of a recent time period is higher than that of a previous time period.

11. The method of claim 1, wherein the identifying of the sustained hotspot external link based on the potential hotspot triple by incorporating the counter values of the current time period and the previous M historical time periods, comprises:
obtaining counter values of the same triple within the current time period and the previous M historical time periods;
inputting the counter values as features into a pre-trained machine learning model; and
predicting the sustained hotspot external link by using the machine learning model.

12. The method of claim 1, wherein the outputting of the identification result of the hotspot external link, comprises:
collating the identification result of the hotspot external link based on area to form an area-based hotspot list; and
based on a preset area priority configuration, performing filtering or weighted sorting on the area-based hotspot list and then outputting the area-based hotspot list.

13. The method of claim 1, further comprising:
periodically cleaning up expired counter data in the multi-level cache;
in a case where an error occurs during cache reading/writing or data processing, recording an exception log containing an error type and cache level; and
performing performance monitoring and optimization based on the exception log.

14. The method of claim 1, further comprising:
continuously writing the identification result of the hotspot external link and a popularity value associated thereto into a long-term aggregation cache structure based on a circular buffer, to maintain historical popularity data for most recent hours; and
generating a historical popularity report reflecting change trend of popularity of the hotspot external link based on data in the long-term aggregation cache structure.

15. The method of claim 14, further comprising:
determining popularity information, duration, and popularity trend based on the identification result of the hotspot external link and/or the historical popularity report; and
collating the popularity information, the duration, and the popularity trend into broadcast information, and pushing the broadcast information to a target terminal.

16. An electronic device, comprising:
at least one processor; and
a memory connected in communication with the at least one processor,
wherein the memory stores an instruction executable by the at least one processor, and the instruction, when executed by the at least one processor, enables the at least one processor to execute:
in response to an operation of a user on an external link, obtaining an external link identifier, an area code of the user and an operation type, to construct a triple counter, wherein each triple counter corresponds to a dimension of (external link, area, operation type);
performing hierarchical processing and filtering on the triple counter via multi-level cache, to identify a potential hotspot triple;
identifying a sustained hotspot external link based on the potential hotspot triple by incorporating counter values of a current time period and previous M historical time periods, wherein M is a positive integer; and
outputting an identification result of the hotspot external link.

17. The electronic device of claim 16, wherein the multi-level cache comprises at least two levels of cache, and
the hierarchical processing and filtering comprise:
in a first-level cache, performing updating and preliminarily filtering on the triple counter according to a first predetermined strategy to obtain a first candidate set;
in a next-level cache, performing further filtering on the first candidate set according to a second predetermined strategy to obtain a second candidate set with a data volume smaller than that of the first candidate set; and
determining the potential hotspot triple based on the second candidate set.

18. The electronic device of claim 17, wherein the at least two levels of cache comprise a first-level cache, a second-level cache, and a third-level cache, and
the hierarchical processing and filtering comprise:
in the first-level cache, updating a counter value with a minute-level time period granularity, and setting a minute-level expiration time for each counter;
in a case where the counter value in the first-level cache exceeds a preset threshold, storing corresponding information into the second-level cache; and
in the third-level cache, periodically querying the second-level cache and sorting obtained triples to filter for the potential hotspot triple.

19. A non-transitory computer-readable storage medium storing a computer instruction thereon, wherein the computer instruction is used to cause a computer to execute:
in response to an operation of a user on an external link, obtaining an external link identifier, an area code of the user and an operation type, to construct a triple counter, wherein each triple counter corresponds to a dimension of (external link, area, operation type);
performing hierarchical processing and filtering on the triple counter via multi-level cache, to identify a potential hotspot triple;
identifying a sustained hotspot external link based on the potential hotspot triple by incorporating counter values of a current time period and previous M historical time periods, wherein M is a positive integer; and
outputting an identification result of the hotspot external link.

20. The non-transitory computer-readable storage medium of claim 19, wherein the multi-level cache comprises at least two levels of cache, and
the hierarchical processing and filtering comprise:
in a first-level cache, performing updating and preliminarily filtering on the triple counter according to a first predetermined strategy to obtain a first candidate set;
in a next-level cache, performing further filtering on the first candidate set according to a second predetermined strategy to obtain a second candidate set with a data volume smaller than that of the first candidate set; and
determining the potential hotspot triple based on the second candidate set.
